(19) United States
(12) Patent Application Publication
(10) Pub. No.: US 2018/0328326 A1
(43) Pub. Date: Nov. 15, 2018

(54) INJECTOR SET-UP HAVING A THERMAL PROTECTION SLEEVE

(71) Applicant: Robert Bosch GmbH, Stuttgart (DE)

(72) Inventors: David Pfefferle, Schwieberdingen (DE); Helmut Denz, Stuttgart (DE); Werner Haarer, Illingen (DE); Christian Steinbrecher, Rossdorf am Forst (DE)

(21) Appl. No.: 15/774,030

(22) PCT Filed: Nov. 18, 2016
(86) PCT No.: PCT/EP2016/078093

§ 371 Date: May 7, 2018

(30) Foreign Application Priority Data
Nov. 27, 2015 (DE) 10 2015 223 605.6

(51) Int. Cl. F02M 53/04; F02M 61/14; F02D 19/02

(52) U.S. Cl. CPC F02M 53/046; F02D 19/027; F02M 61/14

(57) ABSTRACT

An injector device includes a liquid injector for injecting a liquid and a thermal protection sleeve. The liquid injector is situated at least partially in the thermal protection sleeve. The thermal protection sleeve includes a base region having an opening. A spray orifice of the liquid injector is situated near the opening. The thermal protection sleeve includes a first casing region positioned on a first diameter and a second casing region connected to the base region and positioned on a second diameter that is less than the first diameter.

### CROSS-REFERENCE TO RELATED APPLICATIONS

The present application is the national stage of International Pat. App. No. PCT/EP2016/078093 filed Nov. 18, 2016, and claims priority under 35 U.S.C. § 119 to DE 10 2015 223 605.6, filed in the Federal Republic of Germany on Nov. 27, 2015, the content of each of which are incorporated herein by reference in their entireties.

### FIELD OF THE INVENTION

The present invention relates to an injector set-up having a thermal protection sleeve, in order to protect an injector from an overly high thermal loading. In addition, the present invention relates to an internal combustion engine having an injector for liquid fuel and an injector for gaseous fuel.

### BACKGROUND

In vehicles, gaseous fuel, such as natural gas, has recently become more and more interesting on the basis of cost advantages. In this context, for reasons of increasing range and of system redundancy, there is also often the option of operating the vehicle, using liquid fuel in addition to gaseous fuel. In this connection, in addition to the gas injectors for injecting gaseous fuel, the internal combustion engine normally includes injectors for the liquid fuel, as well. During operation using only the gaseous fuel, the liquid injectors are not used. In this case, the injector is filled with fuel, but none flows through it, which means that no heat can be removed from the injector by way of the injection of the liquid fuel. Since the liquid injectors are situated directly at the combustion chamber or near the combustion chamber, high temperature loadings are produced during gas operation of the internal combustion engine. However, the high temperatures may result in damage to the liquid injectors.

### SUMMARY

The injector set-ups of the present invention have an advantage that they render improved thermal shielding of a liquid injector possible during gas operation. This is achieved by the present invention, in that, during gaseous operation, the liquid injector, through which fuel does not flow, is not damaged. This is also achieved by the present invention by positioning a thermal protection sleeve on the liquid injector, the liquid injector being situated at least partially, preferably completely, in the thermal protection sleeve. The thermal protection sleeve surrounds the liquid injector and includes a base region having an opening, a spray orifice or spray orifices of the liquid injector being situated near the opening. In this context, the thermal protection sleeve includes a first and a second casing region. In this case, a first diameter of the first casing region is less than a second diameter of the second casing region. The construction of the thermal protection sleeve is such, that at least the first casing region is connected to the base region. Consequently, the liquid injector is protected by the thermal protection sleeve, in particular, from the thermal effects of a combustion chamber as a result of heat radiation and convection. The flows of heat from the combustion chamber are absorbed by the thermal protection sleeve and drawn off to a cylinder head or the like. Thus, damage to the fluid injector can be prevented. A further advantage is that an engineering change to the fluid injector is not necessary, since the thermal protection sleeve is simply fitted onto the liquid injector. A further advantage of the injector set-up according to the present invention is that a tolerance adjustment, in particular, with regard to an angular tolerance of an installation position of the liquid injector, is also possible with the aid of the thermal protection sleeve.

The second casing region is preferably connected to the base region of the thermal protection sleeve, as well. This allows a highly robust thermal protection sleeve to be provided.

In order to keep the manufacturing costs of the thermal protection sleeve low, the first and the second casing regions are preferably formed in one piece with the base region. A very highly thermally conductive material, in particular, a metallic material, is preferably used as a material for the thermal protection sleeve.

It is particularly preferable for the second casing region to be slotted in the longitudinal direction. This allows an elastic force of the thermal protection sleeve, pointed in the radial direction, to be provided in a simple manner.

According to an alternative embodiment of the present invention, the second casing region is fixed to the first casing region. This is preferably carried out, using a welded connection or the like. This set-up has the advantage that since the second casing region is provided separately from the first casing region, the thermal protection sleeve can be adapted to a different installation situation in a simple and rapid manner, e.g., in the case of different manufacturers of internal combustion engines.

It is also preferable for the first casing region to include a plurality of first tabs, and for the second casing region to include a plurality of second tabs. The tabs are positioned in an alternating manner in the circumferential direction. The positioning on different diameters consequently allows the tabs of the two casing regions to be situated on different diameters, as well. In this manner, an offset external surface of the thermal protection sleeve is produced. It is particularly preferable for the first and second tabs of the two casing regions to have an equal width in the circumferential direction and, in particular, an equal length in the axial direction, as well.

In particular, in order to prevent an additional thermal loading of the liquid injector, the first casing region is preferably set apart from the liquid injector. In this manner, an insulating space filled with air is produced between the first casing region and the liquid injector.

It is further preferable for the second casing region to be mounted in such a manner that an elastic force directed radially outwards is produced. This allows, in particular, simple tolerance compensation, in particular, compensation for angular tolerances, as well, if the liquid injector is installed at a cylinder head in a tilted position.

In order to allow the thermal protection sleeve to be fixed in position in a simple manner, the first casing region is provided with a shoulder directed outwards, at an end away from the base region of the thermal protection sleeve. The shoulder preferably rests against a stop or a surface of the cylinder head. A particularly great advantage of the shoulder directed outwards is that, for example, a cup spring and/or a support ring, in particular, made of brass or aluminum, and/or an annular element for acoustic decoupling, can be mounted. In this manner, in particular, noises, which the liquid injector emits during operation, can be prevented from being transmitted to the cylinder head and to the vehicle.

It is also preferable for the thermal protection sleeve to have a sealing ring, in particular, made of Teflon, on the first casing region, at its inner circumference and/or at its outer circumference. In this way, one more instance of reliable sealing of the bore in the cylinder head is simultaneously implemented by the thermal protection sleeve.

The present invention further relates to an internal combustion engine, including an injector set-up of the present invention for a liquid fuel and a gas injector for injecting a gaseous fuel. It is particularly preferable for the liquid injector and the gas injector to be situated directly next to each other. It is also preferable for the injector set-up to be positioned directly at a combustion chamber of the internal combustion engine, so that direct injection of the liquid and gaseous fuel into the combustion chamber is rendered possible.

In the following, preferred exemplary embodiments of the present invention are described in detail with reference to the accompanying drawing.

### BRIEF DESCRIPTION OF THE DRAWINGS

FIG. 1 is a schematic view of an internal combustion engine having an injector set-up according to a first example embodiment of the present invention.

FIG. 2 is a perspective view of the liquid injector of FIG. 1, according to an example embodiment of the present invention.

FIG. 3 is a schematic sectional view of the injector set-up of FIG. 2, according to an example embodiment of the present invention.

FIG. 4 is a schematic sectional view of an injector set-up according to a second example embodiment of the present invention.

FIG. 5 is a schematic sectional view of an injector set-up according to a third example embodiment of the present invention.

FIG. 6 is a schematic sectional view of an injector set-up according to a fourth example embodiment of the present invention.

### DETAILED DESCRIPTION

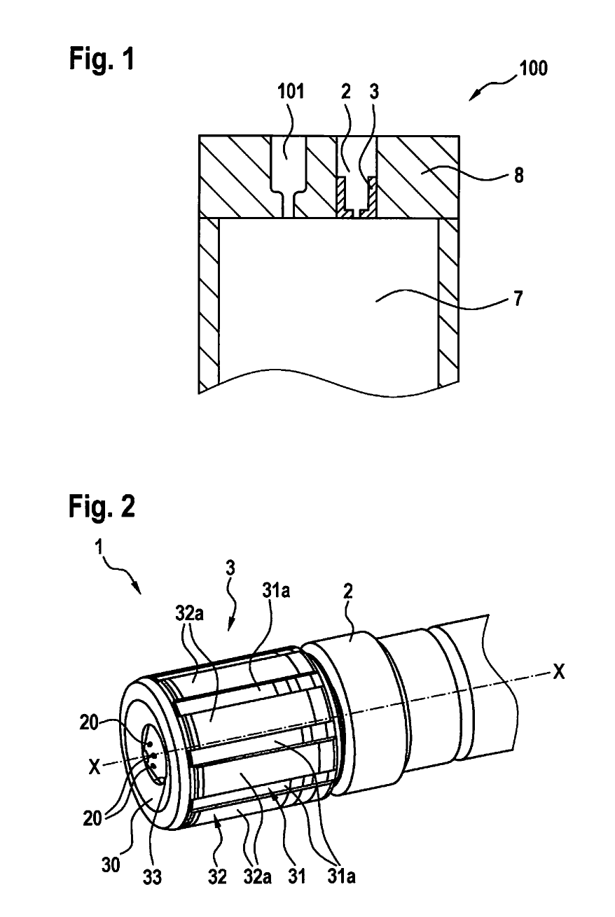

In the following, an injector set-up 1 and an internal combustion engine 100 according to a preferred example embodiment of the present invention is described in detail with reference to FIGS. 1-3.

As is apparent from FIGS. 1 and 2, injector set-up 1 includes a liquid injector 2 and a thermal protection sleeve 3, as well as a gas injector 101.

Thermal protection sleeve 3 surrounds a part of liquid injector 2. As is apparent from FIG. 2, a region of liquid injector 2 pointing towards a combustion chamber 7 is enclosed by thermal protection sleeve 3.

Thermal protection sleeve 3 includes a base region 30, a first casing region 31, and a second casing region 32. A cylindrical opening 33 is provided in base region 30.

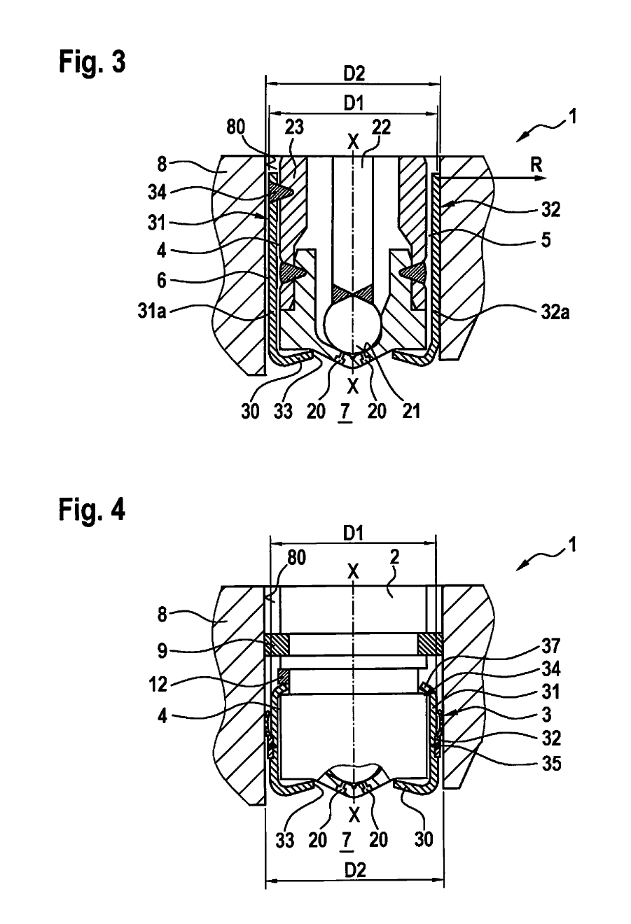

As is apparent from FIG. 3, spray orifices 20 of liquid injector 2 are situated in the region of opening 33 of thermal protection sleeve 3.

In FIG. 3, liquid injector 2 is schematically represented to have a valve seat 21 and a valve needle 22 for uncovering and occluding spray orifices 20.

As is particularly apparent from FIG. 3, thermal protection sleeve 3 has a substantially long cylindrical shape, including a base, in which opening 33 is provided. Therefore, in axial direction X-X of liquid injector 2, thermal protection sleeve 3 covers the end region of liquid injector 2 pointing towards combustion chamber 7.

As is apparent from FIG. 3, first casing region 31 is situated on a first diameter D1, and second casing region 32 is situated on a second diameter D2. In this context, second diameter D2 is greater than first diameter D1.

In this case, each of the two casing regions is made up of a plurality of tabs. The two casing regions are formed in one piece with base region 30. As is apparent from FIG. 1, first casing region 31 is formed by a plurality of first tabs 31a, and second casing region 32 is formed by a plurality of second tabs 32a. In this context, the first and second tabs are each positioned so as to alternate in the circumferential direction.

As is apparent from FIG. 3, thermal protection sleeve 3 is fixed to liquid injector 2 via first casing region 31, using welded connections 34 of first tabs 31a to a housing 23 of liquid injector 2.

In this instance, thermal protection sleeve 3 is fixed to liquid injector 2 in such a manner, that a first gap 4 is provided between first casing region 31, that is, at first tabs 31a, and the outer circumference of liquid injector 2. A second gap 5 is provided between second casing region 32, that is, second tabs 32a, and the outer circumference of liquid injector 2. Due to the positioning of the first and second tabs on different diameters, first gap 4 is smaller than second gap 5.

In addition, a third gap 6 is provided between first casing region 31 and a bore 80 in a cylinder head 8. As is apparent from FIG. 3, second casing region 32, i.e., second tabs 32a, rests directly against bore 80.

Second casing region 32 is now formed in such a manner, that a certain elastic force in radial direction R is present. Thus, for example, when liquid injector 2 is slightly tilted in bore 80, compensation for tolerance can take place with the aid of thermal protection sleeve 3. In particular, this can allow liquid injector 2 to be mounted to a fuel rail.

Second tabs 32a are wider than first tabs 31a in the circumferential direction of thermal protection sleeve 3. In this manner, heat, which is transferred from combustion chamber 7 to thermal protection sleeve 3, is transferred as completely as possible through second tabs 32a to cylinder head 8. In this context, each of second tabs 32a rests against bore 80.

By providing first gap 4 and second gap 5, the first and second tabs of first and second casing regions 31, 32 do not rest against the outer circumference of liquid injector 2. Therefore, an unwanted transfer of heat from thermal protection sleeve 3 back to liquid injector 2 is prevented. In this instance, first and second gaps 4, 5 have an insulating effect.

Since thermal protection sleeve 3 is formed in one piece, it can be fixed to liquid injector 2 in a rapid and simple manner. Opening 33 in base region 30 is formed to be as small as possible, in order to keep a surface of liquid injector 2 pointing towards combustion chamber 7 as small as possible.

Consequently, improved thermal shielding of the liquid injector is attained during exclusive gas operation via an additional gas injector.

FIG. 4 shows an injector set-up 1 according to a second example embodiment of the present invention.

In the second example embodiment, first casing region 31 is formed to be closed in the circumferential direction. First casing region 31 is fixed to the schematically depicted, liquid injector 2 with the aid of a first welded connection 34. In this example embodiment, second casing region 32 is multiply slotted in axial direction X-X, up to free end 37, in order to provide the desired spring action with respect to possible tolerance deviations and tilted mountings of the liquid injector. Second casing region 32 can be made of, for example, a spring steel. Instead of second welded connection 35, second casing region 32 can also be situated in a groove in first casing region 31. Bore 80 is sealed with the aid of a Teflon sealing ring 9. A particular advantage of the second example embodiment is that first casing region 31 is completely closed, which means that hot gases from combustion chamber 7 are not able to get into the annular gap 4 between first casing region 31 and liquid injector 2. It is also noted that instead of the two-piece embodiment having first and second casing regions 31, 32, a one-piece thermal protection sleeve 3 having two casing regions can also be manufactured. To this end, for example, a lathed part having a projecting, second casing region 32 can be manufactured. Subsequently, the slots can be introduced by sawing or lasering or the like.

Instead of welded connection 34, thermal protection sleeve 3 can also be fixed in position with the aid of a compression ring 12, as depicted on the left half of FIG. 4.

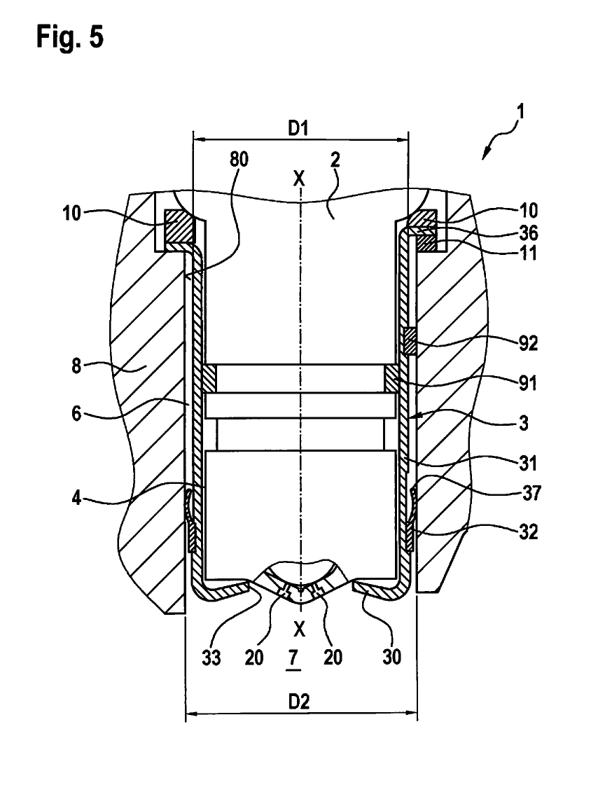

FIG. 5 shows an injector set-up 1 according to a third example embodiment of the present invention. In contrast to the previous example embodiments, in the third example embodiment, thermal protection sleeve 3 is not fixed to liquid injector 2. Thermal protection sleeve 3 includes a shoulder 36, which is formed on first casing region 31 and projects radially outwards. In correspondence with the casing region in the second example embodiment, second casing region 32 is provided with a plurality of slots pointed in the axial direction. First casing region 31 is formed without slots and openings.

As is apparent from FIG. 5, a first sealing ring 91 is provided at the inner circumference, and a second sealing ring 92 is provided at the outer circumference. An annular support element 10 in the form of brass or aluminum is provided on shoulder 26, towards liquid injector 2. In this context, two variants are represented in FIG. 4. On the left half, only support element 10 is provided between shoulder 36 and liquid injector 2. On the right side, shoulder 36 is depicted between support element 10 and a ring 11 for acoustically decoupling the liquid injector from cylinder head 8.

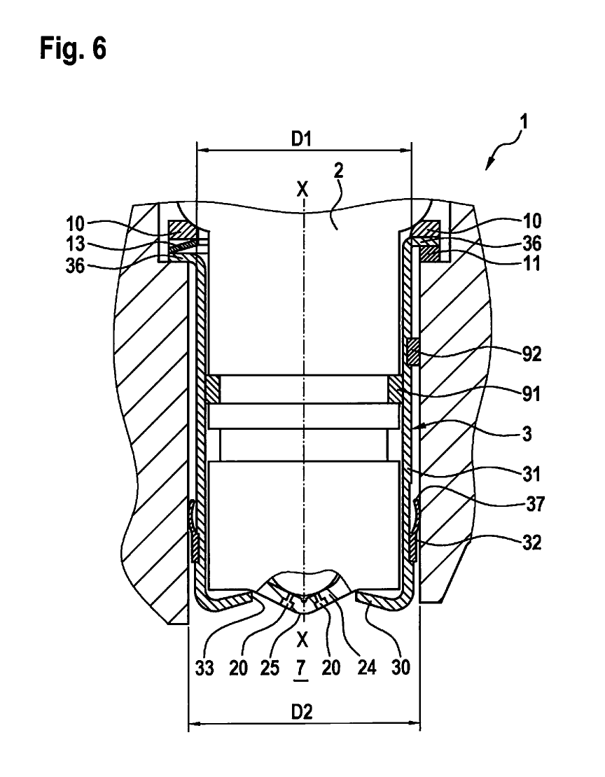

FIG. 6 shows an injector set-up 1 according to a fourth example embodiment of the present invention. The thermal protection sleeve 3 of the fourth example embodiment includes a shoulder 36, as in the third example embodiment. A specific embodiment including cup spring 13 is provided on the left half of FIG. 6. Cup spring 13 is situated between shoulder 36 and a support ring 10. Alternatively, a set-up, as on the right half of FIG. 5, can be provided, in which shoulder 36 is situated between a metallic support ring 10 and a ring 11 for acoustic decoupling.

Cup spring 13 exerts a force in axial direction X-X between liquid injector 2 and thermal protection sleeve 3. In this manner, tolerances between a cone 24, which is on the side of the combustion chamber, and in which spray orifices 20 of liquid injector 2 are provided, and a tip 25 of liquid injector 2 projecting into combustion chamber 7, with respect to thermal protection sleeve 3, can be compensated for. In this manner, compensation can even be provided in the case of changes in length.

Consequently, liquid injector 2 is always pressed against thermal protection sleeve 3 to form a seal.

Therefore, in an internal combustion engine, which includes both a gas injector and a liquid injector, a thermal loading of the liquid injector, which is very high, in particular, during exclusive gas operation, can be reduced significantly by using the thermal protection sleeve of the present invention. The thermal protection sleeve allows thermal shielding of fluid injector 2, as well as removal of heat transferred from combustion chamber 7 to a cylinder head or the like. In addition, the use of thermal protection sleeve 3 allows a tolerance adjustment to be made, in particular, with regard to an angular tolerance of an installation position of liquid injector 2. Thermal protection sleeve 3 can also compensate for instances of thermal expansion.

1-14. (canceled)

15. An injector device, including:
a thermal protection sleeve that includes a base with an opening in the base, a first casing region connected to the base, and a second casing region; and
a liquid injector at least partially situated in the thermal protection sleeve and including a spray orifice that is situated near the opening, wherein the first casing region is at a first radial distance from a central longitudinal axis of the liquid injector and the second casing region is at a second radial distance from the central longitudinal axis of the liquid injector, the second radial distance being greater than the first radial distance.

16. The injector device of claim 15, wherein the second casing region is also connected to the base.

17. The injector device of claim 15, wherein the second casing region includes slots in a direction parallel to the central longitudinal axis.

18. The injector device of claim 15, wherein the second casing region is fixed to the first casing region.

19. The injector device of claim 15, wherein the second casing region is fixed to the first casing region via a welded connection.

20. The injector device of claim 15, wherein the first casing region includes a plurality of first tabs, the second casing region includes a plurality of second tabs, and the first and second tabs being positioned so as to alternate with each other in a circumferential direction.

21. The injector device of claim 15, wherein a space radially separates the first casing region from the liquid injector.

22. The injector device of claim 15, wherein the second casing region provides a force directed radially outwards.

23. The injector device of claim 15, wherein, at an end of the first casing region that is distal from the base, the first casing region includes a shoulder that extends radially outwards.

24. The injector device of claim 23, wherein a least one of a cup spring, a support ring, and a noise-damping ring for acoustic decoupling is situated at the shoulder.

25. The injector device of claim 15, wherein a respective sealing ring is positioned on at least one of an interior of the first casing region and an exterior of the first casing region.

26. The injector device of claim 15, further comprising a gas injector.

27. An internal combustion engine comprising:
a gas injector for injection of gaseous fuel; and
a liquid fuel injector, wherein the liquid fuel injector includes:
a thermal protection sleeve that includes a base with an opening in the base, a first casing region connected to the base, and a second casing region; and
a liquid injector at least partially situated in the thermal protection sleeve and including a spray orifice that is situated near the opening, wherein the first casing region is at a first radial distance from a central longitudinal axis of the liquid injector and the second casing region is at a second radial distance from the central longitudinal axis of the liquid injector, the second radial distance being greater than the first radial distance.

28. The internal combustion engine of claim 27, wherein the liquid fuel injector is situated directly at a combustion chamber of the internal combustion engine.
